(19) United States
(12) Patent Application Publication
(10) Pub. No.: US 2019/0383993 A1
(43) Pub. Date: Dec. 19, 2019

(54) LIQUID CRYSTAL MODULE AND LIQUID CRYSTAL DISPLAY DEVICE

(71) Applicant: HUIZHOU CHINA STAR OPTOELECTRONICS TECHNOLOGY CO., LTD, Huizhou (CN)

(72) Inventor: Chengling LV, Huizhou (CN)

(21) Appl. No.: 15/759,257

(22) PCT Filed: Feb. 28, 2018
(86) PCT No.: PCT/CN2018/077511

§ 371 Date: Mar. 12, 2018

(30) Foreign Application Priority Data
Jan. 30, 2018 (CN) 201810087967.6

(51) Int. Cl. F21V 8/00

(52) U.S. Cl. CPC G02B 6/0085

(57) ABSTRACT

A liquid crystal module and a liquid crystal display device of the present invention utilizes a heat dissipation element disposed on a backplate corresponding in position to a light source. An auxiliary heat dissipation member is disposed on two ends of the heat dissipation element to improve heat dissipation efficiency of the two ends of the heat dissipation element, and further to prevent heat generated by the light source from being conducted to a gate scan driving circuit, thus reducing the risk of failure of the gate scan driving circuit and thus improving reliability of the liquid crystal display device.

### CROSS REFERENCE TO RELATED APPLICATIONS

This application is a U.S. National Phase application submitted under 35 U.S.C. § 371 of Patent Cooperation Treaty Application serial No. PCT/CN2018/077511, filed Feb. 28, 2018, which claims the priority of China Patent Application serial No. 201810087967.6, filed Feb. 28, 2018, the disclosures of which are incorporated herein by reference in their entirety.

### BACKGROUND OF INVENTION

### 1. Field of Invention

The present invention relates to a liquid crystal display technology field, and more particularly to a liquid crystal module and a liquid crystal display (LCD) device.

### 2. Related Art

Gate Driver on Array (GOA) circuits utilize conventional TFT-LCD array process to manufacture a gate scan driving circuit on a TFT substrate, to realize a driving method of progressively scanning in rows. The gate scan driving circuit will be heated during operation, which results in an increase of temperature of the gate scan driving circuit, thus making the gate scan driving circuit ineffective. The gate scan driving circuits, as mentioned, include a left scan driving circuit and a right scan driving circuit.

On the other hand, current existing LCD devices mainly utilize LEDs as a backlight source that has advantages of, such as, compact size, light weight, and power conserving. Moreover, in order to meet needs of more compact, less weight, edge-lit backlight design is implemented in mainstream markets. However, high heat coming from the LED backlight module will be conducted to the gate scan driving circuit and thereby increasing risk of failure of the gate scan driving circuit.

### SUMMARY OF INVENTION

Accordingly, an object of the present invention is to provide a liquid crystal module and a liquid crystal display device to avoid heat generated from a light source being conducted to the gate scan driving circuit, and to reduce the risk of failure of the gate scan driving circuit, whereby improving the reliability of the liquid crystal display device.

To achieve the above-mentioned object, a liquid crystal module of the present invention comprises: a backplate and a light source provided in the backplate; wherein a heat dissipation element is disposed on the backplate corresponding in position to the light source, an auxiliary heat dissipation member is disposed on the heat dissipation element, and the auxiliary heat dissipation member is located corresponding to a left gate scan driving circuit and/or a right gate scan driving circuit;

The auxiliary heat dissipation member comprises a first auxiliary heat dissipation member and a second auxiliary heat dissipation member corresponding in size and shape to the first auxiliary heat dissipation member; and the liquid crystal module further comprises a plastic frame being attached with a thermal insulation material.

In one aspect of the present invention, the first auxiliary heat dissipation member is disposed corresponding to a first heat area on the left gate scan driving circuit, and the second auxiliary heat dissipation member is disposed corresponding to a first heat area on the right gate scan driving circuit.

In another aspect of the present invention, the first auxiliary heat dissipation member and the second auxiliary heat dissipation member are disposed corresponding to a second heat area and a third heat area on the left gate scan driving circuit, respectively.

In another aspect of the present invention, the first auxiliary heat dissipation member and the second auxiliary heat dissipation member are disposed corresponding to a second heat area and a third heat area on the right gate scan driving circuit, respectively.

In another aspect of the present invention, the backplate has a bottom portion and a side portion, a light guiding plate is disposed in a space formed by the bottom portion and the side portion, and the light source is provided between the side portion and the light guiding plate.

In another aspect of the present invention, the thermal insulation material is made of foam, aerogel, or heat insulation paper.

The present invention comprises a liquid crystal module, comprises a backplate and a light source provided in the backplate; wherein a heat dissipation element is disposed on the backplate corresponding in position to the light source, an auxiliary heat dissipation member is disposed on the heat dissipation element, and the auxiliary heat dissipation member is located corresponding to a left gate scan driving circuit and/or a right gate scan driving circuit.

In the liquid crystal module of the present invention, the auxiliary heat dissipation member comprises a first auxiliary heat dissipation member and a second auxiliary heat dissipation member corresponding in size and shape to the first auxiliary heat dissipation member.

In the liquid crystal module of the present invention, the first auxiliary heat dissipation member is disposed corresponding to a first heat area on the left gate scan driving circuit, and the second auxiliary heat dissipation member is disposed corresponding to a first heat area on the right gate scan driving circuit.

In the liquid crystal module of the present invention, the first auxiliary heat dissipation member and the second auxiliary heat dissipation member are disposed corresponding to a second heat area and a third heat area on the left gate scan driving circuit.

In the liquid crystal module of the present invention, the first auxiliary heat dissipation member and the second auxiliary heat dissipation member are disposed corresponding to a second heat area and a third heat area on the right gate scan driving circuit.

In the liquid crystal module of the present invention, the backplate has a bottom portion and a side portion, a light guiding plate is disposed in a space formed by the bottom portion and the side portion, and the light source is provided between the side portion and the light guiding plate.

In the liquid crystal module of the present invention, the liquid crystal module of the invention further comprises a plastic frame being attached with a thermal insulation material.

In the liquid crystal module of the present invention, the thermal insulation material is made of foam, aerogel, or heat insulation paper.

To achieve the above-mentioned object, a liquid crystal display device of the present invention comprises a backplate and a light source provided in the backplate; a heat dissipation element disposed on the backplate corresponding in position to the light source; and an auxiliary heat dissipation member disposed on the heat dissipation element and located corresponding to a left gate scan driving circuit and/or a right gate scan driving circuit.

In the liquid crystal display device of the present invention, the auxiliary heat dissipation member comprises a first auxiliary heat dissipation member and a second auxiliary heat dissipation member corresponding in size and shape to the first auxiliary heat dissipation member.

In the liquid crystal display device of the present invention, the first auxiliary heat dissipation member is disposed corresponding to a first heat area on the left gate scan driving circuit, and the second auxiliary heat dissipation member is disposed corresponding to a first heat area on the right gate scan driving circuit.

In the liquid crystal display device of the present invention, the first auxiliary heat dissipation member and the second auxiliary heat dissipation member are disposed corresponding to a second heat area and a third heat area on the left gate scan driving circuit.

In the liquid crystal display device of the present invention, the first auxiliary heat dissipation member and the second auxiliary heat dissipation member are disposed corresponding to a second heat area and a third heat area on the right gate scan driving circuit, respectively.

In the liquid crystal display device of the present invention, the liquid crystal display device comprises a plastic frame attached with a thermal insulation material.

The advantageous effects of the present invention are as follows: the liquid crystal module of the present invention is to utilize the heat dissipation element disposed on the backplate corresponding in position to the light source, and the auxiliary heat dissipation member disposed on the two ends of the heat dissipation element to improve the efficiency of heat dissipation of the two ends of the heat dissipation element, and further to prevent the heat generated by the light source from being conducted to the gate scan driving circuit, whereby reducing the risk of failure of the gate scan driving circuit and thus improving the reliability of the liquid crystal display device.

### BRIEF DESCRIPTION OF DRAWINGS

FIG. 1 is a schematic structural view of a liquid crystal module in accordance with an embodiment of the present invention;

FIG. 2 is a schematic view showing a layout of the liquid crystal module in accordance with the embodiment of the present invention; and

FIG. 3 is a schematic view showing another layout of the liquid crystal module in accordance with the embodiment of the present invention.

### DESCRIPTION OF PREFERRED EMBODIMENTS

The following embodiments are referring to the accompanying drawings for exemplifying specific implementable embodiments of the present disclosure. Furthermore, directional terms described by the present disclosure, such as upper, lower, front, back, left, right, inner, outer, side, etc., are only directions by referring to the accompanying drawings, and thus the used directional terms are used to describe and understand the present disclosure, but the present disclosure is not limited thereto. In the drawings, elements with similar structures are labeled with like reference numerals.

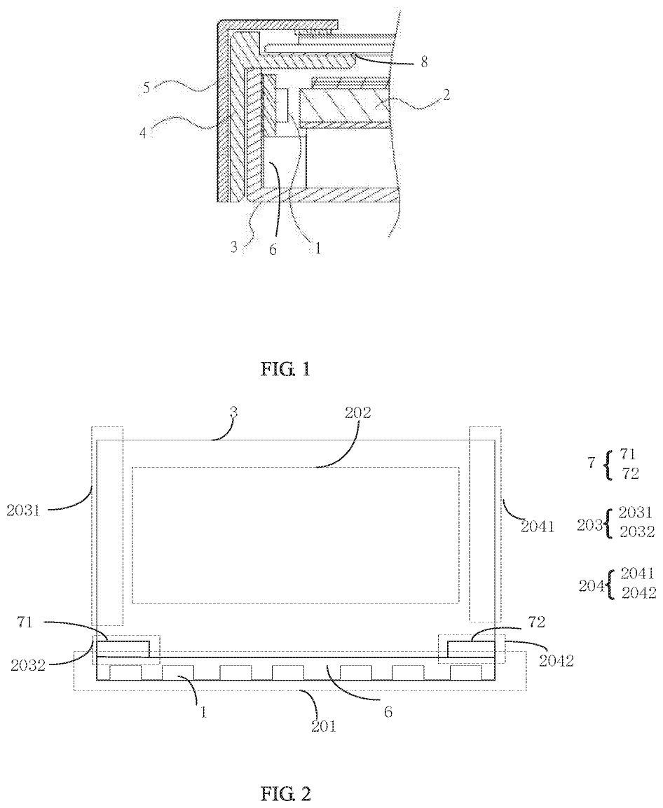

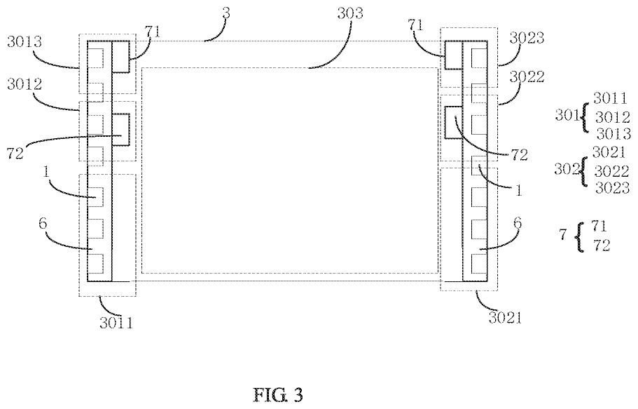

Referring to FIG. 1 and FIG. 2, FIG. 1 is a schematic structural view of a liquid crystal module in accordance with an embodiment of the present invention, and FIG. 2 is a schematic view showing layout of the liquid crystal module. Referring in combination to FIGS. 1 and 2, the liquid crystal module in accordance with the embodiment of the present invention comprises a light source 1, a light guiding plate 2, a backplate 3, a plastic frame 4, and a front frame 5, wherein the light source 1 is provided in the backplate 3. A heat dissipation element 6 is disposed on the backplate 3 corresponding to position of the light source 1, and an auxiliary heat dissipation member 7 is disposed on the heat dissipation element 6 for dissipating heat coming from the light source 1 through the backplate 3 to outside, to avoid the heat from the light source 1 adversely affecting a gate scan driving circuit, thus reducing risk of failure of the gate scan driving circuit. It is noted that, in the present embodiment, the heat dissipation element 6 is made of material capable of dissipating the heat, but not limited thereto in the present invention.

Further, the backplate 3 of the liquid crystal module comprise a light source setting area 201, a light guiding plate setting area 202, a left gate scan driving circuit area 203, and a right gate scan driving circuit area 204. The light source setting area 201 is defined on a longitudinal side of the backplate 3 where the light source 1 is disposed on. The light guiding plate setting area 202 is provided for placing the light guiding plate 2. The light guiding plate 2 is disposed corresponding to the light source 1. The left gate scan driving circuit area 203 and the right gate scan driving circuit area 204 are respectively defined corresponding in position to a left gate scan driving circuit and a right gate scan driving circuit on a TFT substrate of the liquid crystal module, and are disposed on two short sides of the backplate 3. As described above, the heat dissipation element 6 is disposed on the backplate 3 corresponding in position to the light source 1, and the auxiliary heat dissipation member 7 is disposed on the heat dissipation element 6, that is, the auxiliary heat dissipation member 7 is provided to work with the heat dissipation element 6 on the light source setting area 201 of the back light 3 to improve heat dissipation efficiency.

Specifically, each of two ends of the heat dissipation element 6 is provided with the auxiliary heat dissipation member 7. The auxiliary heat dissipation member 7 comprises a first auxiliary heat dissipation member 71 and a second auxiliary heat dissipation member 72. The first auxiliary heat dissipation member 71 is disposed corresponding to a first heat area 2032 on the left gate scan driving circuit, and the second auxiliary heat dissipation member 72 is disposed corresponding to a first heat area 2042 on the right gate scan driving circuit. It is noted that the left gate scan driving circuit area 203 includes the first heat area 2032 which is close to the light source 1, and a fourth heat area 2031 which is far away from the light source 1. Because the first heat area 2032 is closer to the light source 1 than the fourth heat area 2031, a temperature of the first heat area 2032 is higher than that of the fourth heat area 2031. The present invention utilizes the first dissipation member 71 disposed on the heat dissipation element 6 to enhance heat dissipation of the first heat area 2032. Likewise, the right gate scan driving circuit area 204 includes a first heat area 2042 which is close to the light source 1, and a fourth heat area 2041 which is far away from the light source 1. Because the first heat area 2042 is closer to the light source 1 than the fourth heat area 2041, a temperature of the first heat area 2042 is higher than that of the fourth heat area 2041. The present invention utilizes the first dissipation member 72 disposed on another end of the heat dissipation element 6 to enhance heat dissipation of the first heat area 2042.

Preferably, the first dissipation member 71 and the second dissipation member 72 are corresponding to each other in shape and size, so as to ensure an even distribution of heat across both the left and right gate scan driving circuits on the two short sides of the backplate 3.

Referring to FIG. 3 which is a schematic view showing another layout of the liquid crystal module of the present invention, as shown in FIG. 3, the backplate 3 of the liquid crystal module comprises a first light source setting area 301, a second light source setting area 302, and a light guiding plate setting area 303. The light guiding plate setting area 303 is provided for placing the light guiding plate 2. The first light source setting area 301 and the second light source setting area 302 are provided for placing the light source 1. The light guiding plate 2 is disposed corresponding to the light source 1. The first light source setting area 301 is defined corresponding in position to a left gate scan driving circuit on a TFT substrate of the liquid crystal module, and is disposed on a short side of the backplate 3. The second light source setting area 302 is defined corresponding in position to a right gate scan driving circuit on the TFT substrate of the liquid crystal module, and is disposed on another short side of the backplate 3. The heat dissipation element 6 is disposed on the backplate 3 corresponding in position to the light source 1, and the auxiliary heat dissipation member 7 is disposed on each of the two ends of the heat dissipation element 6, that is, each of the first light source setting area 301 and the second light source setting area 302 is provided with the heat dissipation element 6 thereon, whereby the auxiliary heat dissipation member 7 is utilized to improve the efficiency of heat dissipation of the two ends of the heat dissipation element 6.

Specifically, on a side portion of the backplate 3, each of the two ends of the heat dissipation element 6 is provided with the auxiliary heat dissipation member 7. The auxiliary heat dissipation member 7 comprises a first auxiliary heat dissipation member 71 and a second auxiliary heat dissipation member 72. The first auxiliary heat dissipation member 71 is disposed corresponding to a second heat area 3013 on the left gate scan driving circuit, and the second auxiliary heat dissipation member 72 is disposed corresponding to a third heat area 3012 on the left gate scan driving circuit. It is noted that a left gate scan driving circuit area corresponding to the first light source setting area 301 includes the second heat area 3013, the third heat area 3012, and a fifth heat area 3011 below the second heat rear 3013 and the third heat area 3012. The temperature of the second heat area 3013 and the third heat area 3012 is higher than that of the fifth heat area 3011. The present invention utilizes the first auxiliary heat dissipation member 71 and the second auxiliary heat dissipation member 72 to be disposed on the heat dissipation element 6 such that areas of higher temperature are provided with the auxiliary heat dissipation member 7 thereon, so as to enhance heat dissipation of the second heat area 3013 and the third heat area 3012.

On another side portion of the backplate 3, each of the two ends of the heat dissipation element 6 is provided with the auxiliary heat dissipation member 7. The auxiliary heat dissipation member 7 comprise a first auxiliary heat dissipation member 71 and a second auxiliary heat dissipation member 72. The first auxiliary heat dissipation member 71 is disposed corresponding to a second heat area 3023 on the right gate scan driving circuit, and the second auxiliary heat dissipation member 72 is disposed corresponding to a third heat area 3022 on the right gate scan driving circuit. It is noted that a right gate scan driving circuit area corresponding to the second light source setting area 302 includes the second heat area 3023, the third heat area 3022, and a fifth heat area 3021 below the second heat rear 3023 and the third heat area 3022. The temperature of the second heat area 3023 and the third heat area 3022 is higher than that of the fifth heat area 3021. The present invention utilizes the first auxiliary heat dissipation member 71 and the second auxiliary heat dissipation member 72 to enhance heat dissipation of the second heat area 3023 and the third heat area 3022.

Further referring to FIG. 1, the liquid crystal module of the plastic frame 4 is attached with a thermal insulation material 7 in order to reduce heat conduction between the plastic frame 4 and the gate scan driving circuit area. Preferably, the thermal insulation material 7 is made of foam, aerogel, or heat insulation paper.

Further, the backplate 3 has a bottom portion and a side portion, the light guiding plate 2 is disposed in a space formed by the bottom portion and the side portion, and the light source 1 is provided between the side portion and the light guiding plate 2.

The liquid crystal module of the present invention is to utilize the heat dissipation element disposed on the backplate corresponding in position to the light source, and the auxiliary heat dissipation member disposed on the two ends of the heat dissipation element to improve the efficiency of heat dissipation of the two ends of the heat dissipation element, and further to prevent the heat generated by the light source from being conducted to the gate scan driving circuit, whereby reducing the risk of failure of the gate scan driving circuit and thus improving the reliability of a liquid crystal display device.

The present invention further comprises the liquid crystal display device which comprises the liquid crystal module as described above, and thus detailed embodiments can be referred to as described above without repeatedly depiction.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A liquid crystal module, comprising: a backplate and a light source provided in the backplate;
wherein a heat dissipation element is disposed on the backplate corresponding to position of the light source, an auxiliary heat dissipation member is disposed on the heat dissipation element, and the auxiliary heat dissipation member is located corresponding to a left gate scan driving circuit and/or a right gate scan driving circuit;
the auxiliary heat dissipation member comprises a first auxiliary heat dissipation member and a second auxiliary heat dissipation member corresponding in size and shape to the first auxiliary heat dissipation member; and the liquid crystal module further comprises a plastic frame attached with a thermal insulation material.

2. The liquid crystal module of claim 1, wherein the first auxiliary heat dissipation member is disposed corresponding to a first heat area on the left gate scan driving circuit, and the second auxiliary heat dissipation member is disposed corresponding to a first heat area on the right gate scan driving circuit.

3. The liquid crystal module of claim 1, wherein the first auxiliary heat dissipation member and the second auxiliary heat dissipation member are disposed corresponding to a second heat area and a third heat area on the left gate scan driving circuit, respectively.

4. The liquid crystal module of claim 1, wherein the first auxiliary heat dissipation member and the second auxiliary heat dissipation member are disposed corresponding to a second heat area and a third heat area on the right gate scan driving circuit, respectively.

5. The liquid crystal module of claim 1, wherein the backplate has a bottom portion and a side portion, a light guiding plate is disposed in a space formed by the bottom portion and the side portion, and the light source is provided between the side portion and the light guiding plate.

6. The liquid crystal module of claim 1, wherein the thermal insulation material is made of foam, aerogel, or heat insulation paper.

7. A liquid crystal module, comprising a backplate and a light source provided in the backplate;
wherein a heat dissipation element is disposed on the backplate corresponding to position of the light source, an auxiliary heat dissipation member is disposed on the heat dissipation element, and the auxiliary heat dissipation member is located corresponding to a left gate scan driving circuit and/or a right gate scan driving circuit.

8. The liquid crystal module of claim 7, wherein the auxiliary heat dissipation member comprises a first auxiliary heat dissipation member and a second auxiliary heat dissipation member corresponding in size and shape to the first auxiliary heat dissipation member.

9. The liquid crystal module of claim 8, wherein the first auxiliary heat dissipation member is disposed corresponding to a first heat area on the left gate scan driving circuit, and the second auxiliary heat dissipation member is disposed corresponding to a first heat area on the right gate scan driving circuit.

10. The liquid crystal module of claim 8, the first auxiliary heat dissipation member and the second auxiliary heat dissipation member are disposed corresponding to a second heat area and a third heat area on the left gate scan driving circuit.

11. The liquid crystal module of claim 8, wherein the first auxiliary heat dissipation member and the second auxiliary heat dissipation member are disposed corresponding to a second heat area and a third heat area on the right gate scan driving circuit.

12. The liquid crystal module of claim 7, wherein the backplate has a bottom portion and a side portion, a light guiding plate is disposed in a space formed by the bottom portion and the side portion, and the light source is provided between the side portion and the light guiding plate.

13. The liquid crystal module of claim 7, further comprising a plastic frame attached with a thermal insulation material.

14. The liquid crystal module of claim 13, wherein the thermal insulation material is made of foam, aerogel, or heat insulation paper.

15. A liquid crystal display device, comprises:
a backplate and a light source provided in the backplate;
a heat dissipation element disposed on the backplate corresponding to position of the light source; and
an auxiliary heat dissipation member disposed on the heat dissipation element and located corresponding to a left gate scan driving circuit and/or a right gate scan driving circuit.

16. The liquid crystal display device of claim 15, wherein the auxiliary heat dissipation member comprises a first auxiliary heat dissipation member and a second auxiliary heat dissipation member corresponding in size and shape to the first auxiliary heat dissipation member.

17. The liquid crystal display device of claim 16, wherein the first auxiliary heat dissipation member is disposed corresponding to a first heat area on the left gate scan driving circuit, and the second auxiliary heat dissipation member is disposed corresponding to a first heat area on the right gate scan driving circuit.

18. The liquid crystal display device of claim 16, wherein the first auxiliary heat dissipation member and the second auxiliary heat dissipation member are disposed corresponding to a second heat area and a third heat area on the left gate scan driving circuit.

19. The liquid crystal display device of claim 16, wherein the first auxiliary heat dissipation member and the second auxiliary heat dissipation member are disposed corresponding to a second heat area and a third heat area on the right gate scan driving circuit, respectively.

20. The liquid crystal display device of claim 15, further comprising a plastic frame attached with a thermal insulation material.
